(19) United States
(12) Patent Application Publication
(10) Pub. No.: US 2005/0015434 A1
(43) Pub. Date: Jan. 20, 2005

(54) Mobile device with surrogate access to the internet and other networks

(76) Inventor: Yu He, Singapore (SG)

Correspondence Address: HEWLETT-PACKARD DEVELOPMENT COMPANY;Intellectual Property Administration, P.O. Box 272400, Fort Collins, CO, 80527-2400, US

(21) Appl. No.: 10/425,764

(22) Filed: Apr. 29, 2003

(51) Int. Cl. G06F 15/16

(52) U.S. Cl. 709/202; 709/250

(57) ABSTRACT

A wireless mobile device without direct access to the Internet or other data network is provided such access by a surrogate that is already directly connected. For example, a network printer with an infrared port is opportunistically accessed by a PDA lacking its own direct Internet connection. The network printer provides all the network connectivity and protocol processing overhead, and reduces the burden on the PDA or other mobile device to simply that of handling an ordinary serial channel. To the network, the PDA impersonates as the network printer. Such network printer or other similar network surrogate, can impose access restraints on the local mobile devices it will allow to connect this way.

### BACKGROUND

1. Field of the Invention

The present invention relates generally to computer networks, and more particularly to providing mobile devices without their own direct network access a way to opportunistically use a network printer or other resident surrogate.

2. Background of the Invention

Personal digital assistants (PDA), mobile phones, laptops, and other mobile devices are all each more useful when they are connected to the Internet and provided with the ability to browse websites and do e-mail. Mobile phones and some PDA's have their own wireless access to cellphone networks that can support Internet access via an Internet service provider (ISP). Wireless, cellular type modems have also been available for laptop and desktop computers, e.g., from Ricochet Networks (Denver, CO), see www.ricochet.com.

Prior art network access requires mobile devices to be equipped with a wireless LAN card. Such can add costs or be impossible to fit in, as in the case of a mobile phone.

A way is needed for mobile devices to easily access the Internet without requiring expensive network interface controllers, or interfaces.

### SUMMARY OF THE INVENTION

Briefly, a wireless mobile device embodiment of the present invention that lacks direct access to the Internet or other data network is provided with such access by a surrogate that is already directly connected. For example, a network printer with an infrared port is opportunistically accessed by a PDA lacking its own direct Internet connection. The network printer provides all the network connectivity and protocol processing overhead, and reduces the burden on the PDA or other mobile device to simply that of handling an ordinary serial channel. To the network, the PDA impersonates as the network printer. Such network printer or other similar network surrogate, can impose access restraints on the local mobile devices it will allow to connect this way.

An advantage of the present invention is a mobile device lacking an Internet interface can nevertheless be provided Internet access via a surrogate.

Another advantage of the present invention is Internet access can be provided ad hoc by a network printer acting as a network surrogate.

A further advantage of the present invention is that several mobile devices in an area can all share Internet access and local printer services without requiring dedicated printer and Internet connections.

These and other objects and advantages of the present invention will no doubt become obvious to those of ordinary skill in the art after having read the following detailed description of the preferred embodiment as illustrated in the drawing figures.

### BRIEF DESCRIPTION OF THE DRAWINGS

FIG. 1 is a functional block diagram of a system embodiment of the present invention that allows a mobile device to have easy, inexpensive indirect access to a network through a surrogate;

FIG. 2 is a dataflow diagram of the software at work in the system of FIG. 1;

FIG. 3 is a browser to Internet sequence diagram that represents network access in the system of FIG. 1; and

FIGS. 4 and 5 each illustrates step-by-step part of the process processing an HTTP message by TCP/IP stack.

### DETAILED DESCRIPTION OF THE INVENTION

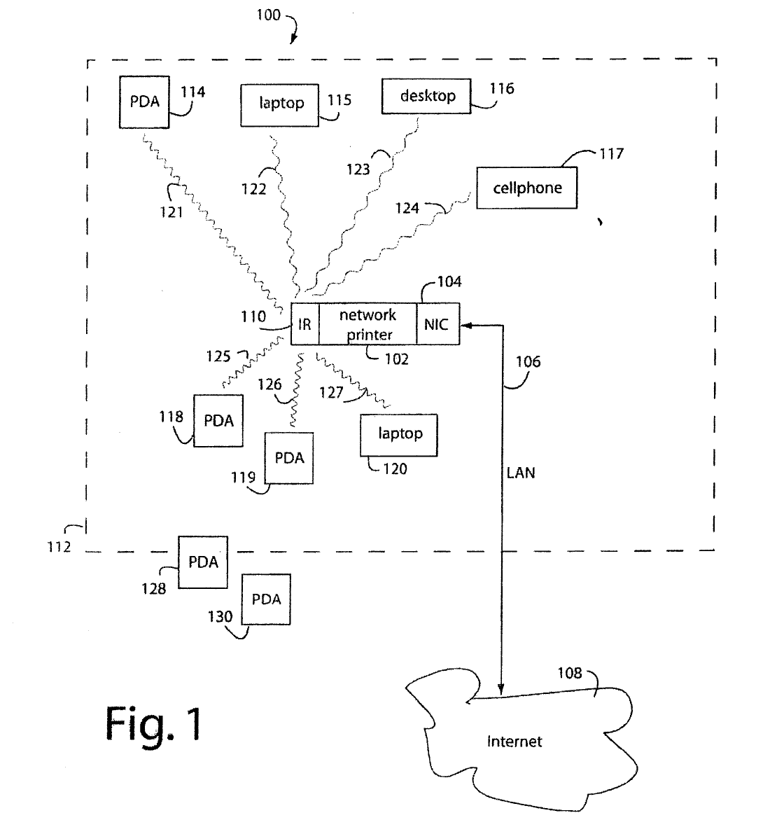

FIG. 1 illustrates a surrogate network embodiment of the present invention, and is referred to herein by the general reference numeral 100. Such surrogate network 100 is based on a network printer 102 that is strategically placed and situated in an office, service area, or customer area. For example, a coffee shop in which the retail business provides the printer and seats and tables to rest laptop computers that make ad hoc connections to both the printer and the Internet. As a further example, the network printer is placed in a gas station and mobile devices associated with cars randomly enter and exit the gas station. Such mobile devices sense the opportunistic connection made available to the Internet and automatically download and upload files via a simple serial link.

A network interface controller (NIC) 104 has its own IP-address on a local area network (LAN) 106, and has a permanent, high speed connection to the Internet 108. An infrared (IR) port 110 is part of the network printer 102 and is ordinary used for nearby computers to be able to download printing jobs without requiring an interface cable. The limits of the IR communication range are represented by a border 112. Furthermore, the network printer 102 has computing capabilities.

Such network printer 102 is thus in a position to act as a surrogate to carry Internet traffic from any device that can access the infrared port 110. The software to support this is added to an otherwise conventional printer with LAN interfaces and infrared ports. Bluetooth, or other wireless technology could be substituted for the infrared ports, but such would require much more hardware and software to support the connection than an infrared serial port in a mobile device. A Bluetooth connection could also make its own LAN connection without the assistance of the network printer 102.

A plurality of mobile devices, e.g., personal digital assistants (PDA's), desktop computers, and cellphones 114-120 is shown communicating over simple serial links 121-127 respectively. Each mobile device has an infrared port for communicating with the network printer 104. Data are transmitted over the infrared ports as byte stream in the exemplary embodiment. A PDA 128 and 130 are shown outside border 112 and will establish communication with Internet 108 when inside the service area.

In one embodiment of the present invention, the network printer 102 automatically detects and establishes connections through the infrared ports with the PDAs, desktop computers, and cellphones 114-120, as they appear within border 112.

A commercial software platform, Chai, can be included in network printer 102 implementations. The network printer 102 can be implemented with an HP LaserJet 4100N, (Hewlett-Packard Company of Palo Alto, Calif.). Chai is targeted for embedded device and mainly includes the components of the Chai Virtual Machine (Chai VM), ChaiServer, and optional ChaiServices. Chai VM provides an execution environment for programmable objects called ChaiServices. Such services can perform simple or complex computations and are executed by ChaiServer as Java applications. ChaiServer is an application server, which integrates objects written in Java with web server access technology.

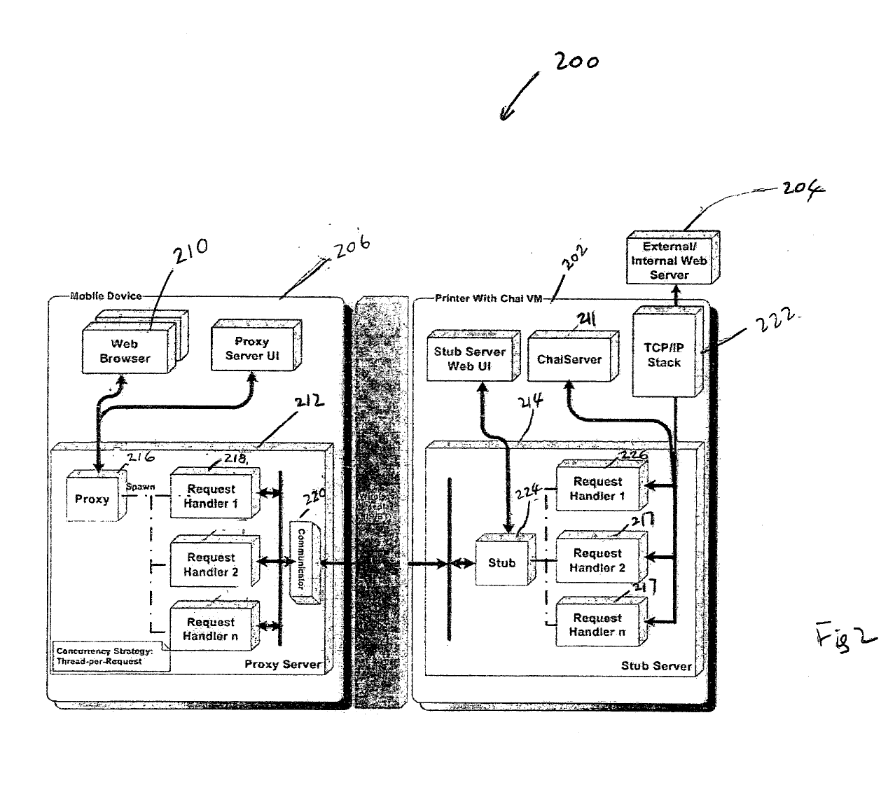

FIG. 2 represents a system embodiment of the present invention, and is referred to herein by the general reference numeral 200. The system 200 includes a printer 202 connected to a web server 204 through the Internet. A mobile device 206 has wandered into the reach of a wireless media service 208. Web browser or window of a web browser 210 is connected by a proxy server 212 to a stub server 214. This allows ad hoc web browser connections by the mobile device user through to the web server 204 and the Internet.

Proxy server 212 is a software always running in the background. The proxy server 212 constantly listens for HTTP requests at a default IP 127.0.0.1, for example, through a user-specified port, 5000. The proxy setting of the web browser 210 can also be set as the IP 127.0.0.1 and the port 5000, which makes the proxy server 212 transparent to mobile users. Whenever a URL is invoked in the web browser 210, an HTTP request is automatically sent to the proxy server 212, which sends the HTTP request as-is as byte stream over the infrared communication ports to the network printer 202. Then, the proxy server 212 waits for an HTTP response in response to the request from the network printer 202. The proxy server 212 mainly has three components, namely, proxy 216, request handler 218 and communicator 220. The proxy 216 is responsible for establishing connection with the web browser 210, the request handle 218 is responsible for processing the HTTP request from the web browser 210 and the corresponding HTTP response from the network printer 202, and the communicator 220 takes care of the communication with the network printer 202 over the infrared communication ports.

Stub server 214 can be implemented with software that executes in the network printer 202 under CHAI VM. The stub server 214 constantly waits for the incoming byte streams from the mobile device 206 over the infrared communication ports. When the stub server 214 receives the HTTP request from the mobile device 206, it analyses the HTTP request header and gets relevant information, such as the host name/IP of the targeted web server 204, the version of HTTP etc. Subsequently, the stub server 214 compiles a new HTTP request, forwards it to the web server 204 through TCP/IP stack 222 and waits for the response. When the stub server 214 gets an HTTP response from the targeted web server 204 through the TCP/IP stack 222, it then forwards the response as byte stream over the infrared communication ports to the proxy server 212. Finally, the proxy server 212 forwards the HTTP response to the web browser 210, which presents the web contents to the mobile users. Stub server 214 mainly has two components, namely, stub 224 and request handler 226. The stub 224 is responsible for establishing connection with the proxy server 212 in the mobile device 206, and the request handler 226 is responsible for processing the HTTP request from the mobile device 206 and the corresponding HTTP response received form the web server 204.

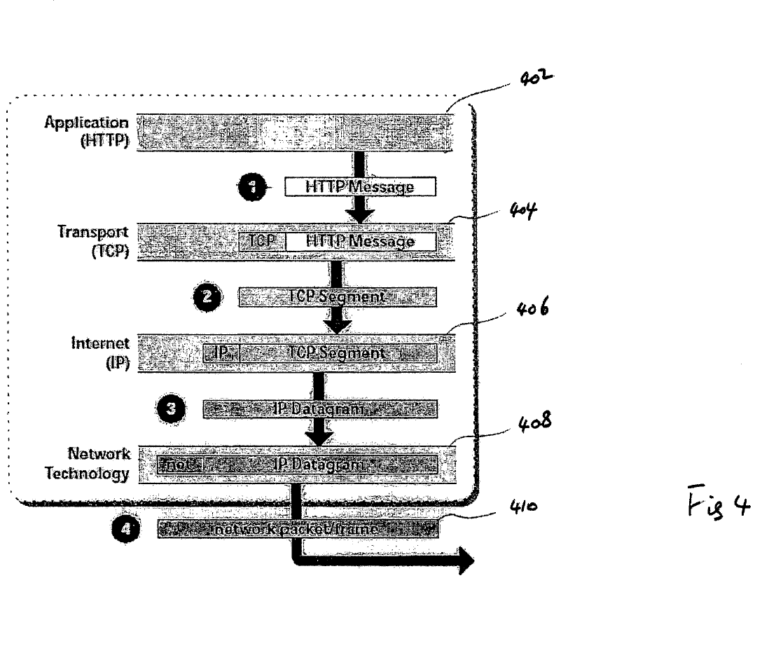

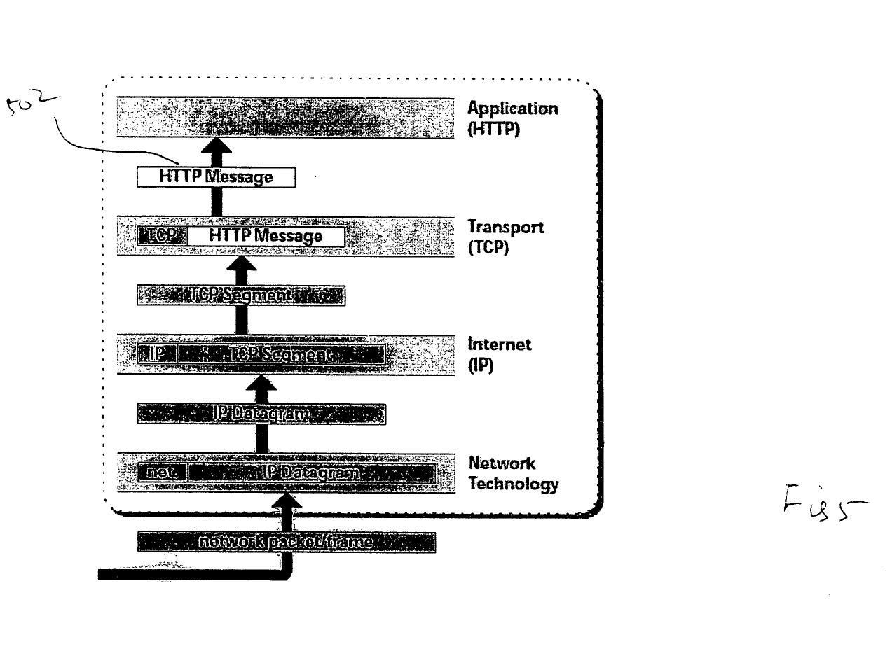

The TCP/IP stack 222 is a software implemented in the real-time operating system of the network printer 202. The TCP/IP stack 222 compiles a TCP/IP packet based upon the HTTP request from the stub server 214 for transmitting to the web server 204 over the Intemet 108. The TCP/IP stack 222 also parses the TCP/IP packet from the web server 204 and extracts the HTTP response therein, which comes from the web server 204 in response to the HTTP request. A brief description of compiling and parsing the TCP/IP packet is herein provided with reference to FIGS. 4 and 5.

In FIG. 4, the stub server 214 calls SendRequesto, which calls Java socket API OutputStream.write(), to send out an HTTP request in step 402. In step 404, a TCP process provided by the TCP/IP stack 222 then adds some TCP-specific information such as TCP header to the HTTP request and thereby creates a TCP segment. In step 406, the TCP process passes the TCP segment to an IP process also provided by the TCP/IP stack 222. The IP process adds some IP-specific information such as IP header to the TCP segment, and this results in an IP datagram. In step 408, the IP datagram reaches the protocol implementation, which controls the network technology and which again adds some more information to the IP datagram. Only after that, in step 410, the HTTP request processed by the stub server 214 leaves the network printer 202, in the form of a TCP/IP packet.

FIG. 5 illustrates an example of parsing the TCP/IP packet by the host of the web server 204. Basically, it is a reverse of the process of compiling the TCP/IP packet as described with reference to FIG. 4. Each protocol layer accepts the message, processes it as it needs, and passes the extracted information to the next protocol layer. In step 502, the HTTP request from the network printer 202 arrives at the web server application.

The communication between the network printer 202 and the web server 204 is bidirectional. The HTTP response in response to the request will also be packed into a TCP/IP packet by the web server 204 and sent over the Internet 105 to the network printer 202, which subsequently parses the TCP/IP packet.

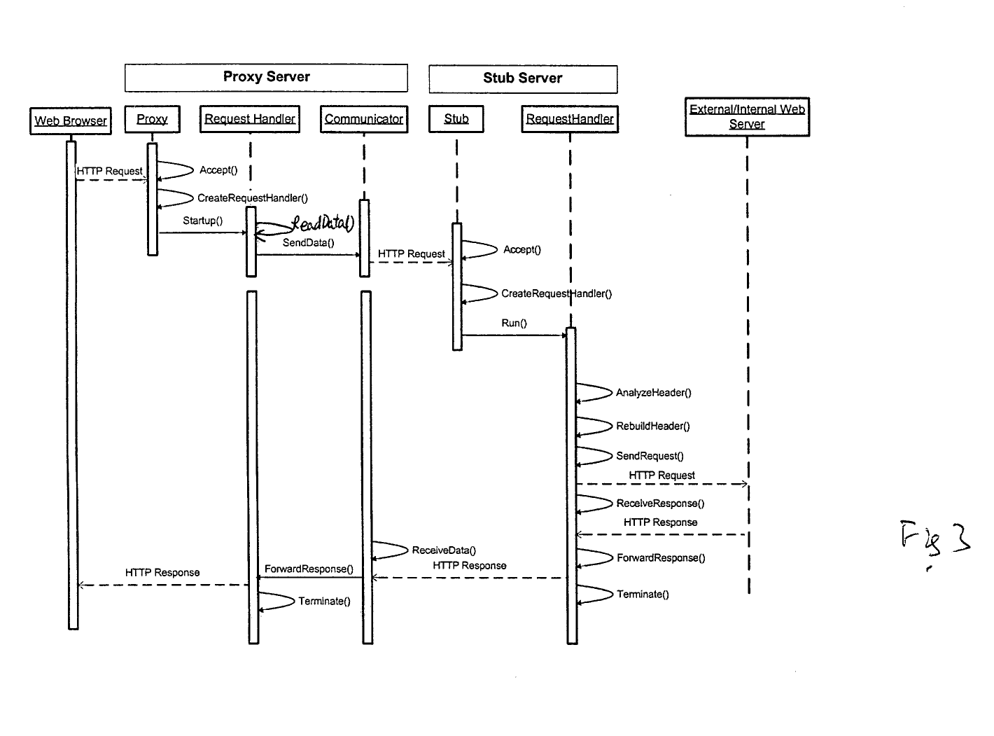

FIG. 3 illustrates a scenario that a user of the mobile device 206 accesses the targeted web server 204 through the network printer 202. The operating system in the mobile device 206 is Windows CE (POCKET PC) Version 3.0. The Chai software in the network printer is version 3.0. The Proxy server 212 is implemented using C# language and runs under WinCE Net Compact Framework. In the exemplary embodiment, the stub server 214 is implemented in Java and runs as a ChaiService under Chai VM and Chai Server.

Firstly, the user of the mobile device 206 invokes a request for accessing the targeted web server 204 by entering the URL of the targeted web server 204, for example, http://www.hp.com, in the web browser 210, which is Internet Explorer in the exemplary embodiment. Internet Explorer generates an HTTP request in the following illustrative format:
GET http://www.hp.com/HTTP/1.1
Accept: */*
UA-OS: Windows CE (POCKET PC)−Version 3.0
UA-color: color16
UA-pixels: 240×320
UA-CPU: ARM SA1110
UA-Voice: FALSE
UA-Language: JavaScript
Accept-Encoding: gzip, deflate
User-Agent: Mozilla/2.0 (compatible; MSIE 3.02; Windows CE; PPC; 240×320)
Host: 17.0.0.9
Proxy-Connection: Keep-Alive
Pragma: No-Cache

The proxy 205 is initially in a blocking state by calling the WinSocket function Accept( ). Accept( ) returns a new socket for a newly created connection after accepting a connection request from the web browser 210. The proxy 205 also creates a request handler 207 by calling CreateRequestHandler( ), which takes the new socket as argument, and activates it by calling Startup( ) function. Then the above-described HTTP request is sent to the request handler 207. The proxy 205 returns to the blocking state of Accepto for the next incoming connection request from the web browser 210. The request handler 207 is a separate thread that processes one HTTP request. The request handler 207 transmits the HTTP request to the network printer 202 by calling the function SendData( ) provided by the communicator 209.

A connection has been established between the communicator 209 of proxy server 212 in the mobile device 206 and the stub 215 of the stub server 214 in the network printer 202 before SendData( ) is called. In the proxy server 212, the communicator 209 calls the methods in the class IrDAEndPoint, which is provided by .Net Framework Class Library, to issue a connection request. In the stub server 214, the stub 215 calls Accepto to accept the connection request.

The request handler 217 of the stub server 214 is a separate thread created and activated by the stub 215 to deal with the HTTP request from the mobile device 206.

These operations are done by AnalyzeHeader( ) and RebuildHeader( ). In AnalyzeHeader( ), the host name of the targeted web server 204 identified by “www.hp.com” is extracted from the HTTP request header and its IP address is obtained by calling the method in Java Class Library InetAddress.getByName( “www.hp.com”). Before SendRequest() is called, a connection has already been established between the network printer 202 and the web server 101 by the request handler calling Java socket API SocketStream openConnection( ).

Subsequently the TCP/IP stack 219 receives the modified HTTP request from the stub server 214 and then compiles a TCP/IP packet based upon the modified HTTP request in the following illustrative format:
IP header TCP header TCP/IP data (HTTP request).
   Such a TCP/IP packet will then be sent from the network printer 202 to the web server 204 over the Internet 105.

When the TCP/IP packet reaches the web server 204, the HTTP request is extracted. In response to the HTTP request, the web server retrieves the information as designated in the HTTP request and generates an HTTP response. The HTTP response is further converted into a TCP/IP packet by the TCP/IP stack installed in the host of the web server 204 for transmitting over the Internet 105 to the network printer 202.

When the HTTP Response is received by ReceiveResponse()of a request handler 217 of the stub server 214, ForwardResponse() is called to forward the HTTP Response to the proxy server 212 over the infrared communications ports as byte stream. When this is done, the request handler thread terminates itself.

The communicator 220 gets the HTTP Response by calling ReceiveData(), and the HTTP response is forwarded to the web browser 210 by the request handler 218, which then terminates itself. Finally, the web browser 210 presents the content in the HTTP response to the mobile user.

In an alternative embodiment of the present invention, information is transmitted between the PDA and the network printer through infrared communication ports. If both the PDA and the network printer support Bluetooth technologies, the information can be transmitted over Bluetooth communication ports accordingly.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

1. An ad hoc network, comprising:
a network surrogate for connection to a web server through a network interface controller (NIC);
a wireless service area transceiver supported by the network surrogate and providing for communication with a plurality of mobile device visitors to the service area; and
a stub server for translating web browsing requests and responses between said web server and any of said plurality of mobile device visitors to the service area.

2. The ad hoc network of claim 1, further comprising:
an infrared link included in the wireless service area transceiver.

3. A process for accessing a network, comprising:
providing a mobile device that lacks direct access to the network;
providing a surrogate directly connected to the network;
impersonating the mobile device as the surrogate in the network; and
providing the mobile device with access to the network through the surrogate and its connection to the network.

4. The process of claim 3, wherein both the mobile device and the surrogate have an infrared port for communication therebetween, the process further comprising:
sending network access requests from the mobile device to the surrogate over the infrared ports as byte stream.

5. The process of claim 3, further comprising:
sending a network access request from the mobile device to the surrogate in a first format not suitable for transmission over the network; and
translating the network access request into a second format suitable for transmission over the network by the surrogate.

6. A process for accessing a web server from a mobile device, comprising:
sending an HTTP web access request from the mobile device to a network printer as byte stream over infrared ports, the network printer having access to the web server;
compiling a TCP/IP web access request based on the HTTP web access request on behalf of the mobile device by the network printer;
sending the TCP/IP web access request from the network printer to the web server;
receiving a TCP/IP web access response from the web server by the network printer;
parsing the TCP/IP web access response by the network printer to retrieve an HTTP response incorporated therein; and
sending the HTTP response from the network printer to the mobile device as byte stream over the infrared ports.
